(19) United States
(12) Patent Application Publication
(10) Pub. No.: US 2026/0172733 A1
(43) Pub. Date: Jun. 18, 2026

(54) RECHARGEABLE EAR-WORN DEVICE WITH A MAGNETIC INTERFACE

(71) Applicant: Starkey Laboratories, Inc., Eden Prairie, MN (US)

(72) Inventors: Joshua Elliot Braband, Eden Prairie, MN (US); Thomas Olai Monsen, Carver, MN (US); Omkar Prakash Joshi, Minneapolis, MN (US)

(21) Appl. No.: 19/409,138

(22) Filed: Dec. 4, 2025

Related U.S. Application Data
(60) Provisional application No. 63/733,213, filed on Dec. 12, 2024.

(51) Int. Cl. H04R 1/1025

(52) U.S. Cl. CPC H04R 1/1025

(57) ABSTRACT

Embodiments herein relate to ear-worn devices magnetic rechargeable interfaces. In an embodiment, an ear-worn device system for listening includes having a first ear-worn device having a first ear-worn device charging structure having an ear-worn device alignment structure with a magnetic material; and a charger case having a first case charging structure and a case alignment structure, wherein the first case charging structure includes a first case electrical contact, wherein the case alignment structure includes a first pole-aligned magnet and a second pole-aligned magnet having opposite poles and positioned on a first side of the case alignment structure, wherein the magnetic material is magnetically attracted to the first pole-aligned magnet and the second pole-aligned magnet. Other embodiments are also included herein.

This application claims the benefit of U.S. Provisional Application No. 63/733,213, filed Dec. 12, 2024, the content of which is incorporated herein by reference in its entirety.

### FIELD

Embodiments herein relate to ear-worn devices and more particularly to ear-worn devices having magnetic interfaces.

### BACKGROUND

Ear-worn devices are configured to provide audio input to the ears of a user. Some examples of hearing devices are headsets, hearing aids, speakers, cochlear implants, bone conduction devices, and personal listening devices. Hearing devices often include a rechargeable battery that can be recharged, but can become depleted during daily use, leaving the user without the benefit of a functioning hearing device.

Charging cases are included with ear-worn device systems to recharge batteries. It can be challenging to ensure that the charging contacts on the case firmly engage with charging contacts on the ear-worn device to support a reliable and efficient charging process.

### SUMMARY

In a first aspect, an ear-worn device system for listening can be included having a first ear-worn device can include a speaker, a rechargeable battery, a first ear-worn device charging structure can include a first ear-worn device electrical contact, and an ear-worn device alignment structure can include a magnetic material, and a charger case can include a first case charging structure and a case alignment structure, wherein the first case charging structure includes a first case electrical contact, wherein the case alignment structure includes a first pole-aligned magnet and a second pole-aligned magnet, and wherein the first pole-aligned magnet and the second pole-aligned magnet can be opposite poles and can be positioned on a first side of the case alignment structure, and wherein the magnetic material can be magnetically attracted to the first pole-aligned magnet and the second pole-aligned magnet, and wherein the first ear-worn device can be configured to be positioned within the charger case so that the first ear-worn device electrical contact can be in electrical communication with the first case electrical contact within the charger case, and wherein the ear-worn device alignment structure can be configured to retain the first ear-worn device electrical contact to the first case electrical contact within the charger case.

In a second aspect, in addition to one or more of the preceding or following aspects, or in the alternative to some aspects, the first pole-aligned magnet includes a north pole and the second pole-aligned magnet includes a south pole.

In a third aspect, in addition to one or more of the preceding or following aspects, or in the alternative to some aspects, the case alignment structure includes a third pole-aligned magnet.

In a fourth aspect, in addition to one or more of the preceding or following aspects, or in the alternative to some aspects, the case alignment structure includes a fourth pole-aligned magnet.

In a fifth aspect, in addition to one or more of the preceding or following aspects, or in the alternative to some aspects, the first pole-aligned magnet and the second pole-aligned magnet can be bar magnets.

In a sixth aspect, in addition to one or more of the preceding or following aspects, or in the alternative to some aspects, the first pole-aligned magnet and the second pole-aligned magnet can be positioned adjacent to one another.

In a seventh aspect, in addition to one or more of the preceding or following aspects, or in the alternative to some aspects, the first pole-aligned magnet and the second can be in contact with each other.

In an eighth aspect, in addition to one or more of the preceding or following aspects, or in the alternative to some aspects, the magnetic material does not retain its magnetism when removed from the charger case.

In a ninth aspect, in addition to one or more of the preceding or following aspects, or in the alternative to some aspects, a retention force of equal to or greater than 0.7 Newtons (N) can be present between the first ear-worn device and the charger case when the first ear-worn device alignment structure can be positioned at least partially within an indentation of the charger case.

In a tenth aspect, in addition to one or more of the preceding or following aspects, or in the alternative to some aspects, the retention force can be equal to or less than 2.5 N when the first ear-worn device alignment structure can be positioned at least partially within the indentation of the charger case.

In an eleventh aspect, in addition to one or more of the preceding or following aspects, or in the alternative to some aspects, the first pole-aligned magnet and the second pole-aligned magnet can be included in a horseshoe magnet.

In a twelfth aspect, in addition to one or more of the preceding or following aspects, or in the alternative to some aspects, the first pole-aligned magnet and the second pole-aligned magnet include a material selected from the group consisting of neodymium and samarium-cobalt.

In a thirteenth aspect, in addition to one or more of the preceding or following aspects, or in the alternative to some aspects, the magnetic material includes a material selected from the group consisting of stainless steel, an iron-cobalt alloy, a silicon iron alloy, and a nickel iron alloy.

In a fourteenth aspect, in addition to one or more of the preceding or following aspects, or in the alternative to some aspects, a magnetic permeability of the magnetic material can be between 300 H/m and 180,000 H/m.

In a fifteenth aspect, an ear-worn device system for listening can be included having a first ear-worn device can include a speaker, a rechargeable battery, a first ear-worn device charging structure can include at least two first ear-worn device electrical contacts, and an ear-worn device alignment structure can include a magnetic material, and a charger case can include a first case charging structure and a case alignment structure, wherein the first case charging structure includes at least two first case electrical contacts, wherein the case alignment structure includes a first pole-aligned bar magnet and a second pole-aligned bar magnet, and wherein the first pole-aligned bar magnet and the second pole-aligned bar magnet can be opposite poles and can be positioned on a first side of the case alignment structure, and wherein the magnetic material can be magnetically attracted to the first pole-aligned bar magnet and the second pole-aligned bar magnet, and wherein the first ear-worn device can be configured to be positioned within the charger case so that the at least two first ear-worn device electrical contacts can be in electrical communication with the least two first case electrical contacts within the charger case, wherein the ear-worn device alignment structure can be configured to retain the at least two first ear-worn device electrical contacts to the at least two first case electrical contacts within the charger case, and wherein the magnetic material does not retain its magnetism when removed from the charger case.

In a sixteenth aspect, in addition to one or more of the preceding or following aspects, or in the alternative to some aspects, the first pole-aligned bar magnet includes a north pole and the second pole-aligned bar magnet includes a south pole.

In a seventeenth aspect, in addition to one or more of the preceding or following aspects, or in the alternative to some aspects, a retention force of equal to or greater than 0.7 N can be present between the first ear-worn device and the charger case when the first ear-worn device alignment structure can be positioned at least partially within an indentation of the charger case.

In an eighteenth aspect, in addition to one or more of the preceding or following aspects, or in the alternative to some aspects, the retention force can be equal to or less than 2.5 N when the first ear-worn device alignment structure can be positioned at least partially within the indentation of the charger case.

In a nineteenth aspect, in addition to one or more of the preceding or following aspects, or in the alternative to some aspects, the first pole-aligned bar magnet and the second pole-aligned bar magnet include a material selected from the group consisting of neodymium and samarium-cobalt.

In a twentieth aspect, in addition to one or more of the preceding or following aspects, or in the alternative to some aspects, the magnetic material includes a material selected from the group consisting of stainless steel, an iron-cobalt alloy, a silicon iron alloy, and a nickel iron alloy.

### BRIEF DESCRIPTION OF THE FIGURES

Aspects may be more completely understood in connection with the following figures (FIGS.), in which:

FIG. 1 is a perspective view of an ear-worn device in accordance with various embodiments herein.

FIG. 2 is a side perspective view of the ear-worn device of FIG. 1 in accordance with various embodiments herein.

FIG. 3 is a perspective view of a charger case in accordance with various embodiments herein

FIG. 4 is a perspective view of a case charging port in accordance with various embodiments herein.

FIG. 5 is a perspective view of an ear-worn device in the case charging port of FIG. 4, in accordance with various embodiments herein.

FIG. 6 is a cross-sectional view of the ear-worn device in the case charging port of FIG. 5, where the plane of the cross-section is indicated by line 6-6 in accordance with various embodiments herein.

FIG. 7 is an exploded view of the case charging port of FIG. 4 in accordance with various embodiments herein.

FIG. 8 is a perspective of a case charging port in accordance with various embodiments herein.

FIG. 9 is a perspective view of an ear-worn device in an alternate case charging port, in accordance with various embodiments herein.

FIG. 10 is a cross-sectional view of the ear-worn device in the case charging port of FIG. 9, where the plane of the cross-section is indicated by line 10-10 in accordance with various embodiments herein.

FIG. 11 is an exploded view of the case charging port of FIG. 9 in accordance with various embodiments herein.

FIG. 12 is a cross-sectional view of the ear-worn device in the case charging port of FIG. 6, where the plane of the cross-section is indicated by line 12-12 in accordance with various embodiments herein.

FIG. 13 is a schematic diagram of a polarity alignment of a pair of magnets with a magnetic material in accordance with various embodiments herein.

FIG. 14 is a cross-sectional view of an ear-worn device in a case charging port having a horseshoe magnet in accordance with various embodiments herein.

FIG. 15 is a cross-sectional view of an ear-worn device in a case charging port having three magnets in accordance with various embodiments herein.

FIG. 16 is a cross-sectional view of an ear-worn device in a case charging port having four magnets in accordance with various embodiments herein.

FIG. 17 is a graph of the attraction force between different alloys and magnet pairings in accordance with various embodiments herein.

FIG. 18 is a schematic block diagram shown with various components of an ear-worn device in accordance with various embodiments herein.

FIG. 19 is a schematic block diagram shown with various components of a charger case in accordance with various embodiments herein.

While embodiments are susceptible to various modifications and alternative forms, specifics thereof have been shown by way of example and drawings and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

In recent years, there has been a shift towards rechargeable hearing aids. Rechargeable batteries offer several advantages over their disposable counterparts, including the convenience of not having to regularly purchase and replace batteries, the ability to easily recharge the device, and a reduced environmental footprint. However, the process of recharging these devices has itself presented challenges. Traditional charging methods often involve precise alignment of the device with charging contacts, which can be fiddly and difficult for users with limited dexterity. Furthermore, the charging contacts are susceptible to wear and tear as well as corrosion over time, potentially affecting the reliability of the charging process.

Magnetic interfaces for charging ear-worn devices represent a significant leap forward in addressing these issues. Magnetic charging interfaces simplify the process of aligning the device with the charger, reducing the need for precise placement and thereby enhancing the user experience. This approach not only improves the ease of use but also increases the durability and reliability of the charging process by minimizing physical wear and corrosion risks associated with traditional charging contacts.

However, magnetic interfaces that include a magnet in the charger case and a magnet in the ear-worn device can cause problems. The magnet in the ear-worn device generates magnetic fields even when the ear-worn device is outside the charger case, which can impact the performance of internal components of the ear-worn device reliant on the detection of magnetic fields.

The present application seeks to address the limitations of magnet-to-magnet attraction forces by introducing an ear-worn device with an optimized magnetic interface for charging, offering a seamless and efficient solution to the challenges currently faced by users of rechargeable hearing aids and similar devices. Specifically, it has been found that replacing the magnet in the ear-worn device with a magnetic material, such as a soft magnetic alloy, and adding a pair of magnets in the charger case allows for appropriate attraction forces between the charger case and the ear-worn device while eliminating excess magnetic fields within the ear-worn device when worn by the user.

In various embodiments, an ear-worn device system can include an ear-worn device and a charger case. The ear-worn device can include a speaker, a rechargeable battery, an ear-worn device charging structure, and an ear-worn device alignment structure. The ear-worn device charging structure can include at least one ear-worn device electrical contact. The ear-worn device alignment structure can include a magnetic material, such as a soft magnetic alloy.

The charger case can include a case charging structure and a case alignment structure. The case charging structure can include at least one case electrical contact. The case alignment structure can include a first pole-aligned magnet and a second pole-aligned magnet. In various embodiments, the first pole-aligned magnet and the second pole-aligned magnet can have opposite poles and can be positioned on a first side of the case alignment structure. In various embodiments, the magnet material can be magnetically attracted to the first pole-aligned magnet and the second pole-aligned magnet.

In various embodiments, the ear-worn device can be positioned within the charger case so that the at least one ear-worn device electrical contact is in electrical communication with the at least one case electrical contact within the charger case. Additionally, in some embodiments, the ear-worn device alignment structure can retain the at least one ear-worn device electrical contact to the least one case electrical contact within the charger case.

In various embodiments, the magnetic material will not retain its magnetism when removed from the charger case. In various embodiments, a retention force of between 0.7 N and 2.5 N is present between the ear-worn device and the charger case when the ear-worn device alignment structure is positioned at least partially within an indentation of the charger case.

In various embodiments, the first pole-aligned magnet and the second pole-aligned magnet can be made from neodymium or samarium-cobalt. In various embodiments, the magnetic material can be made from steel, an iron-cobalt alloy, a silicon iron alloy, a nickel iron alloy, or a mixture thereof.

### Ear-Worn Devices

The term “ear-worn device” as used herein shall refer to devices that can aid a person with impaired hearing. The term “ear-worn device” shall also refer to devices that can produce optimized or processed sound for persons with normal hearing. Ear-worn devices herein can include hearables (e.g., wearable earphones, headphones, earbuds, virtual reality headsets), hearing aids (e.g., hearing instruments), cochlear implants, and bone-conduction devices, for example. Hearing aids include, but are not limited to, behind-the-ear (BTE), in-the ear (ITE), in-the-canal (ITC), invisible-in-canal (IIC), receiver-in-canal (RIC), receiver in-the-ear (RITE) or completely-in-the-canal (CIC) type hearing aid assemblies or some combination of the above. In some embodiments, ear-worn devices may comprise a contralateral routing of signal (CROS) or bilateral microphones with contralateral routing of signal (BiCROS) amplification system. In some embodiments herein, an ear-worn device may also take the form of a piece of jewelry, including the frames of glasses, which may be attached to the head on or about the ear. The structures and components described herein can also be used in an ear-worn device that is not a hearing assistance device, such as a medical monitoring device. Ear-worn devices can also be referred to as ear-wearable devices.

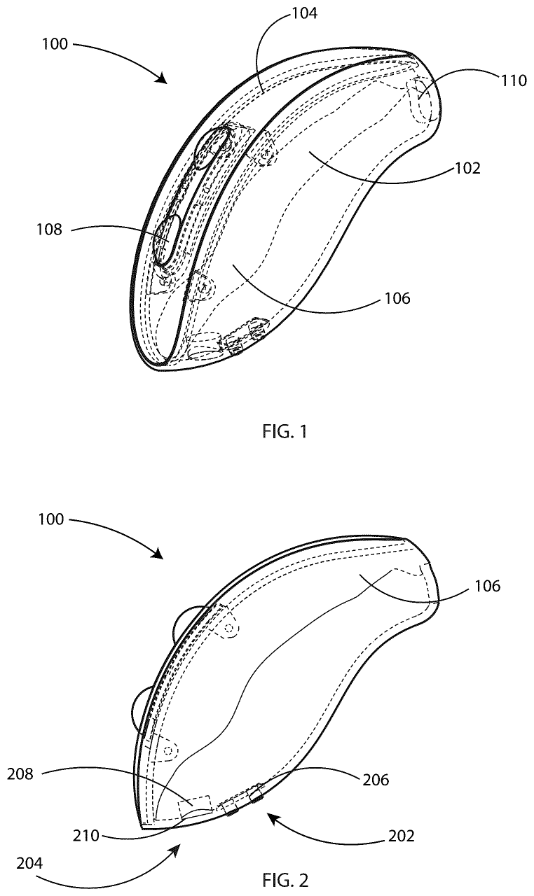

Referring now to FIG. 1, a perspective view of an ear-worn device is shown in accordance with various embodiments herein. The ear-worn device 100 can include an ear-worn device housing 102. In various embodiments, the ear-worn device housing 102 is adapted to be worn on or behind an ear of a wearer. The ear-worn device housing 102 is configured rest against a user's outer ear in a behind-the-ear orientation. The ear-worn device housing 102 can be manufactured utilizing any suitable technique or techniques, e.g., injection-molding, 3D printing, etc. The ear-worn device housing 102 can include any suitable material or materials, e.g., silicone, urethane, acrylates, flexible epoxy, acrylated urethane, and combinations thereof. In various embodiments, the ear-worn device housing 102 can be formed from a top case 104 and a bottom case 106. In some embodiments, the top case 104 is removably attached to the bottom case 106 by means of any of or a combination of adhesive, a snap fit, press fit, a pin connection, or the like.

In various embodiments, the ear-worn device 100 can include user input device 108. The user input device 108 is designed to be intuitive and accessible, allowing users to perform functions without the need to remove the device from their ear. In the example of FIG. 1, the user input device 108 is disposed on the top case 104 of the ear-worn device housing 102 but other placements of the user input device are possible. In various embodiments, the user input device 108 can include one or more buttons, switches, or the like, such as a first button and a second button. For example, a volume up button and a volume down button can be included in the user input device. In various embodiments, the ear-worn device user can interact with the user input device 108 (e.g., by pressing one or more buttons) to adjust the volume, turn the ear-worn device on or off, adjust the balance between ambient sound and audio playback, change audio profiles based on the listening environment, or activate a power-saving mode.

While FIG. 1 illustrates tactile interactions provided by the user input device 108, it is contemplated herein that the user input device 108 can operate via hands-free operation. For example, the user input device 108 can operate through voice commands or remote control via a connected smartphone application. In some embodiments where voice commands are enabled, a microphone integrated into the ear-worn device 100 can pick up spoken instructions from the user, allowing for hands-free operation. This feature can be particularly useful in situations where the user's hands are occupied or when the device is difficult to reach. In other embodiments, a dedicated smartphone application can offer a graphical interface for controlling the ear-worn device 100, enabling users to customize settings, check battery levels, and even locate a misplaced device through the application.

In various embodiments, the ear-worn device 100 can include a speaker 110. The speaker 110 can be integrated within the ear-worn device housing 102 using a combination of press-fit, adhesive bonding, or ultrasonic welding to ensure a robust and vibration-free assembly. The speaker 110 can be configured to deliver high-quality audio output directly to the user's ear. The speaker 110 can be fabricated from a variety of materials known for their acoustic properties, including, but not limited to, lightweight polymers for the diaphragm, neodymium for the magnet, and aluminum or copper for the voice coil, ensuring a balance between durability and optimal sound delivery. It is noted that the choice of materials aims to provide a clear, distortion-free listening experience even at high volumes, while also maintaining the overall device's lightness for user comfort.

The speaker 110 can be designed in various shapes and sizes. For example, the speaker 110 can be circular, oval, rectangular, polygonal, or even custom-shaped speakers can be utilized depending on the specific acoustic and ergonomic requirements of the ear-worn device.

In various embodiments, the ear-worn device housing 102 can contain one or more electronic components, which will be described in further detail herein. The electronic components can be disposed in any suitable location or arrangement within the ear-worn device housing 102 and can receive power from a rechargeable battery housed in the ear-worn device 100. In various embodiments, the rechargeable battery can be any suitable type of rechargeable battery including, but not limited to NiCd (Nickel-Cadmium), NiMH (Nickel-Metal Hydride), Li-ion (Lithium Ion), or the like.

Referring now to FIG. 2, a side perspective view of the ear-worn device of FIG. 1 is shown in accordance with various embodiments herein. The ear-worn device 100 includes an ear-worn device charging structure 202 including one or more electrical contacts 206.

The one or more electrical contacts 206 can establish an electrical connection between the ear-worn device 100 and the charger case, discussed below, thereby enabling the transfer of power necessary for recharging the ear-worn device's battery.

The electrical contacts 206 can be made from a variety of conductive materials known for their electrical conductivity and resistance to corrosion. Materials can include, but are not limited to, gold, silver, copper, and their alloys. For example, gold-plated contacts, known for their superior resistance to oxidation, can be used.

The ear-worn device 100 can further include the ear-worn device alignment structure 204. The ear-worn device alignment structure 204 ensures the correct positioning and secure attachment of the ear-worn device 100 within the charger case, thereby facilitating efficient and reliable charging.

In various embodiments, the ear-worn device alignment structure 204 can include a magnetic material 208. The magnetic material 208 can be made from a variety of materials, including soft magnetic alloys. These materials are chosen for their ability to concentrate magnetic flux, which enhances the magnetic coupling between the ear-worn device 100 and the charger case. This can ensure a strong, reliable connection that is resistant to wear and tear, thus extending the lifespan of the ear-worn device 100. Furthermore, the materials are selected to maintain their magnetic properties over a wide range of temperatures, ensuring consistent performance regardless of environmental conditions. For example, the magnetic material 208 can be made from stainless steel, iron-cobalt alloys, silicon iron alloys, and nickel iron alloys. In some embodiments, the magnetic material 208 can be made from Stainless 430F, Permenorm 5000 H2® Iron Cobalt, silicon-iron, or nickel-iron.

The dashed lines in FIG. 1 show the inner geometry of the ear-worn device housing 102, including the inner boundary of the housing 102, according to various embodiments, and many of those features are also illustrated in FIG. 2. The magnetic material 208 can fit into a recess 210 defined in the inner surface of housing 102 or be otherwise retained in a position that allows for appropriate attraction forces.

### Charger Case

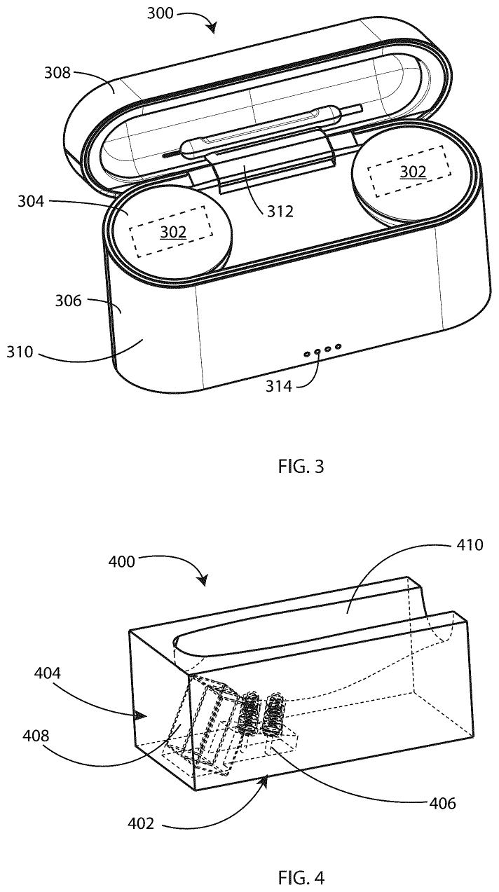

Referring now to FIG. 3, a perspective view of a charger case is shown in accordance with various embodiments herein. Embodiments of the charger case 300 are directed to storing, protecting, and charging ear-worn device(s) contained within the charger case. Ear-worn devices can be stored charged in one or more case charging ports 302 discussed in further detail below. In various embodiments, the charger case 300 may be configured to move between an open position and a closed position. The case may be sized to be easily held in a human hand, easily held in a typical pocket of clothing, and easily transported. As a result of the ease of transportation, a user is more likely to bring the case along with the user when away from home or even within the home. A safe place for storing the ear-worn devices and the ability to charge the ear-worn devices is therefore more likely to be close at hand to the user. In various embodiments, the case may be opened and closed with a single human hand.

In various embodiments, the charger case 300 can have a top surface 304 and one or more case charging ports 302 defined in the top surface 304 configured to receive an ear-worn device and provide power to a rechargeable battery contained within the ear-worn device. In various embodiments, each case charging port 302 includes an indentation shaped to be a negative of a portion of the ear-worn device housing that includes the ear-worn device alignment structure discussed above with respect to FIGS. 1 and 2. In one embodiment, the charger case 300 has two case charging ports 302 configured to accommodate two ear-worn devices at a given time. However, the charger case 300 can include any suitable number of case charging ports to accommodate any number of ear-worn devices such as a single case charging port or three or more case charging ports.

The charger case 300 can have a case main body 306 and a lid 308. The case main body 306 can further include a case battery and case electronics 310 configured to charge one or more ear-worn devices among other optional functions. The case main body 306 can be connected to the lid 308 by a hinge 312 such that the lid can move the case between an open and closed position.

In various embodiments, the charger case 300 can be configured or adapted such that the ear-worn devices contained within the charger case 300 are charging when the case is in a closed position, and, for example, not charging when the case is in the open position. Specifically, the case may include one or more contact points that interact with one another when the case is in the closed position to charge the ear-worn devices. As such, a user knows that the ear-worn devices contained within the case are charging when the case is in a closed position. In one or more embodiments, the case may also be configured or adapted such that the ear-worn devices contained within the case may charge when the case is in the open position.

In various embodiments, the charger case 300 can include case display 314 to provide a visual indicator regarding the status of components within the charger case 300. In an exemplary embodiment, the display can include one or more LEDS. For example, the case display 314 may communicate the power level/status of the ear-worn devices. The case display 314 can be located anywhere on the charger case 300, such as the case main body 306 or the lid 308.

### Case Charging Ports (FIGS. 4-7)

In various embodiments, a charger case can include a case charging port configured to receive an ear-worn device and position the ear-worn device to enable charging of the battery. Referring now to FIG. 4, a perspective view of a portion of a case charging port 400 is shown in accordance with various embodiments herein. A charger case can include one or more case charging ports 400. The one or more case charging ports 400 can be integrated within the charger case through various manufacturing techniques, including, but not limited to, injection molding, CNC machining, or additive manufacturing processes.

In various embodiments, each case charging port 400 can include a case charging structure 402 and a case alignment structure 404. The case charging structure 402 can include one or more electrical contacts 406 configured to charge the ear-worn device. The case alignment structure 404 can include one or more magnets 408 configured to align the ear-worn device to the case charging structure 402. The case alignment structure 404 can further include an indentation 410 configured to receive an ear-worn device. The indentation 410 can be shaped such that a portion of the ear-worn device can only be inserted into the case charging port 400 in an orientation that enables the case charging structure 402 to align with an ear-worn device charging structure.

Referring now to FIG. 5, a perspective view of an ear-worn device in the case charging port is shown in accordance with various embodiments herein. FIG. 5 illustrates an ear-worn device 100 positioned within a portion of a case charging port 400. When the ear-worn device 100 is positioned within the case charging port 400, the charging case can recharge the battery of the ear-worn device 100.

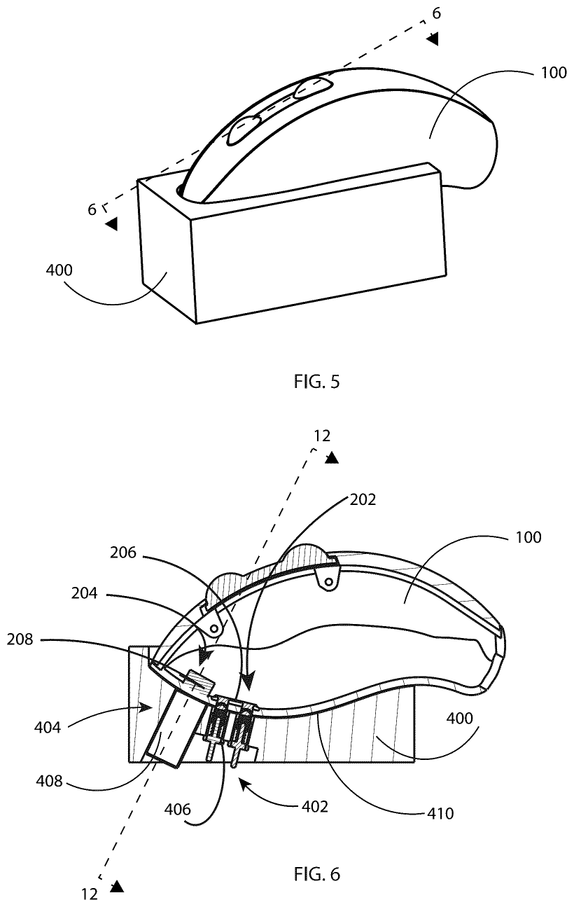

Referring now to FIG. 6, a cross-sectional view of the ear-worn device in the case charging port of FIG. 5 is shown in accordance with various embodiments herein. FIG. 6 illustrates the alignment of the ear-worn device 100 within the case charging port 400. To facilitate proper alignment of the ear-worn device 100 within the case charging port 400, the ear-worn device 100 can include an ear-worn device alignment structure 204 that interacts with a case alignment structure 404. In various embodiments, the ear-worn device alignment structure 204 includes a magnetic material 208, such as a soft magnetic alloy and the case alignment structure 404 includes one or more magnets 408. As such, the one or more magnets 408 pulls the ear-worn device 100 into the case charging port 400.

To further facilitate the positioning of the ear-worn device 100 within the case charging port 400, the case alignment structure 404 can include an indentation 410. In various embodiments, the indentation 410 can be shaped to be a negative of the housing of the ear-worn device alignment structure 204. As such the indentation 410 can receive the ear-worn device alignment structure 204 ensuring the ear-worn device 100 can only be inserted into the case charging port 400 in an orientation that allows the ear-worn device charging structure 202 to align and interact with a case charging structure 402. In various embodiments, the indentation 410 can be shaped to allow the ear-worn device 100 to be positioned and aligned horizontally within the case charging port 400.

Once aligned, electrical contacts 206 of the ear-worn device charging structure 202 establish a direct electrical connection with electrical contacts 406 of the case charging structure 402 to recharge the battery within the ear-worn device 100. This magnetic alignment mechanism not only simplifies the process of placing the ear-worn device 100 into the case charging port 400 but also prevents incorrect placement that could potentially damage the electrical contacts or result in inefficient charging.

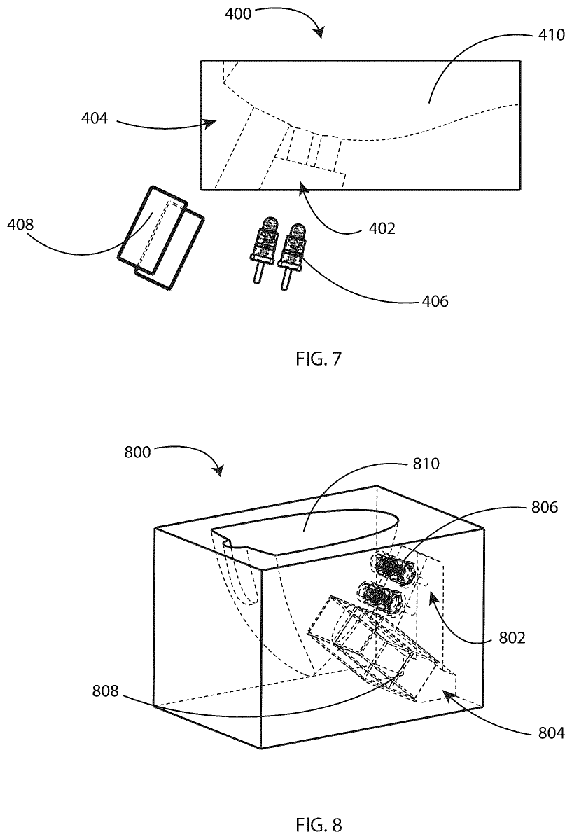

Referring now to FIG. 7, an exploded view of the case charging port of FIG. 4 is shown in accordance with various embodiments herein. As illustrated, the case charging port 400 can include the case charging structure 402 and the case alignment structure 404. The case charging structure 402 can include at least two electrical contacts 406 configured to charge the ear-worn device. In various embodiments, each electrical contact 406 of the case includes a spring, cantilevered contact, conductive elastomer, or other structure, feature, or material which can help ensure a reliable connection by applying consistent pressure against the mating electrical contact of the ear worn device. This pressure pushes the contacts together, maintaining a stable electrical connection even if there are slight movements or misalignments.

The case alignment structure 404 can include at least two magnets 408 configured to align the ear-worn device charging structure with the case charging structure 402. The case alignment structure 404 can further include the indentation 410 further configured to align the ear-worn device charging structure with the case charging structure 402.

### Case Charging Ports With Alternate Indentation Orientation (FIGS. 8-11)

In alternative embodiments, the charger case can include one or more case charging ports having an indentation that positions the ear-worn device(s) vertically during charging. It is noted that the descriptions, materials, and functionalities discussed above with respect to the case charging ports in FIGS. 4-7 are also applicable to the case charging ports in FIGS. 8-11. Referring now to FIG. 8, a perspective view of a case charging port is shown in accordance with various embodiments herein.

In various embodiments, each case charging port 800 can include a case charging structure 802 and a case alignment structure 804. The case charging structure 802 can include one or more electrical contacts 806 configured to charge the ear-worn device. The case alignment structure 804 can include one or more magnets 808 configured to align the ear-worn device to the case charging structure 802. The case alignment structure 804 can further include an indentation 810 configured to receive an ear-worn device.

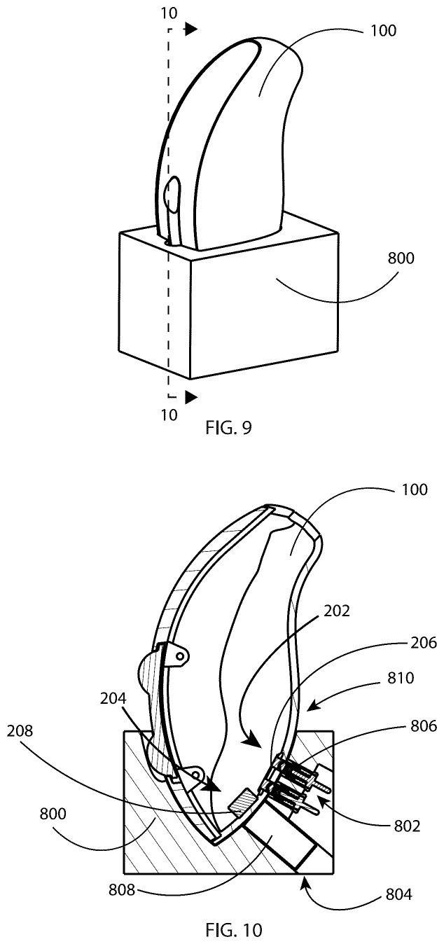

Referring now to FIG. 9, a perspective view of an ear-worn device in a case charging port is shown in accordance with various embodiments herein. FIG. 9 illustrates an ear-worn device 100 positioned within case charging port 800. When the ear-worn device 100 is positioned within the case charging port 800, the ear-worn device 100 can recharge its battery.

Referring now to FIG. 10, a cross-sectional view of the ear-worn device in the case charging port of FIG. 9 is shown in accordance with various embodiments herein. FIG. 10 illustrates the alignment of the ear-worn device 100 within the case charging port 800. The ear-worn device 100 can include an ear-worn device alignment structure 204 that interacts with a case alignment structure 804. In various embodiments, the ear-worn device alignment structure 204 includes a magnetic material 208, such as a soft magnetic alloy and the case alignment structure 804 includes one or more magnets 808.

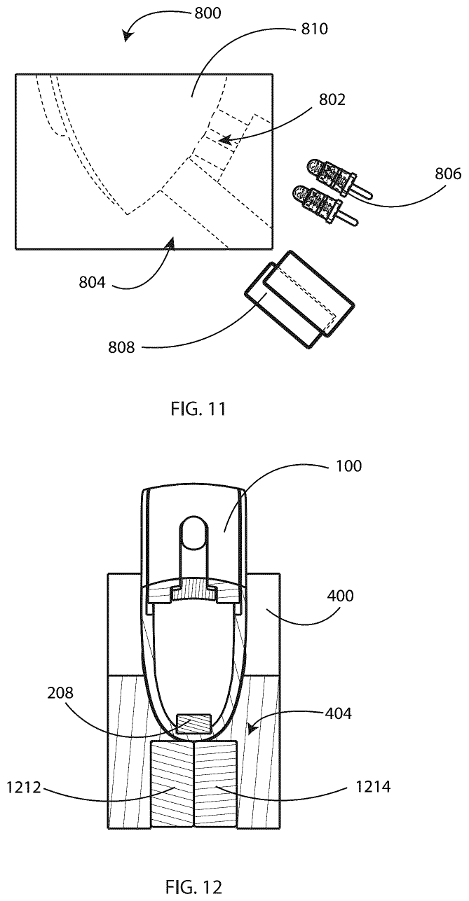

In various embodiments, the case alignment structure 804 can include an indentation 810. In various embodiments, the indentation 810 can be shaped to be a negative of the housing of the ear-worn device alignment structure 204 and a portion of the top case of the ear-worn device 100. By having the indentation 810 be the negative shape of the ear-worn device alignment structure 204 and a portion of the top case of the ear-worn device 100, it ensures that the ear-worn device 100 can only be inserted into the case charging port 800 in an orientation that allows the ear-worn device charging structure 202 to align and interact with a case charging structure 802. In various embodiments, the indentation 810 can be shaped to allow the ear-worn device 100 to be positioned and aligned vertically within the case charging port 800. Referring now to FIG. 11, an exploded view of the case charging port of FIG. 8 is shown in accordance with various embodiments herein. As illustrated, the case charging port 800 can include the case charging structure 802 and the case alignment structure 804. The case charging structure 802 can include at least two electrical contacts 806 configured to charge the ear-worn device. The case alignment structure 804 can include at least two magnets 808 configured to align the ear-worn device charging structure with the case charging structure 802. The case alignment structure 804 can further include the indentation 810 further configured to align the ear-worn device charging structure with the case charging structure 802.

### Magnetic Alignment Mechanism

In various embodiments, the ear-worn device alignment structure and the case alignment structure utilize a magnetic alignment mechanism to correctly align the ear-worn device within the case charging port.

Referring now to FIG. 12, a cross-sectional view of the ear-worn device in the case charging port of FIG. 6 is shown in accordance with various embodiments herein. In various embodiments, the case charging port 400 can include a case alignment structure 404. The case alignment structure 404 can include a first pole-aligned magnet 1212 and a second pole-aligned magnet 1214. To align the ear-worn device 100 within the case charging port 400, the magnetic material 208 and the first pole-aligned magnet 1212 and the second pole-aligned magnet 1214 are magnetically attracted to each other, as will be discussed further below.

In various embodiments, the magnetic material 208 can be made from a variety of materials known for their high magnetic permeability and low coercivity, such as a blend of iron, nickel, and cobalt. These materials are selected for their ability to easily magnetize and demagnetize, which is beneficial for the temporary magnetic attraction required during the alignment and charging process. For instance, the alloy may comprise a specific ratio of iron and nickel, known as mu-metal, which is highly effective at providing a path for magnetic flux, thereby concentrating the magnetic field generated by the magnets in the charger case. In some embodiments, the magnetic material 208 can be made from Stainless 430F, Permenorm 5000 H2® Iron Cobalt, silicon-iron, or nickel-iron.

The magnetic material 208 can be made into various shapes and sizes to fit precisely within the ear-worn device alignment structure. For example, the magnetic material 208 can be molded into thin sheets, rods, discs, or other custom shapes. The size of the magnetic material 208 can be tailored to maximize magnetic interaction without adding unnecessary bulk to the ear-worn device. The thickness of the magnetic material 208 can vary. In some embodiments, the magnetic material 208 can range from 0.1 mm to 5 mm. For example, the magnetic material 208 can have a thickness of 0.5 mm, 1.5 mm, 2.5 mm, 3.5 mm, 4.5 mm, 5 mm, or any thickness in between. It is further noted that while the magnetic material 208 is illustrated as a separate component within the ear-worn device 100, it is envisaged that could form all or a portion of the ear-worn device housing.

In various embodiments, magnets 1212 and 1214 can be positioned within the case alignment structure 404. In some embodiments, the magnets 1212 and 1214 can be bar magnets. The magnets 1212 and 1214 can be made from various materials. In some embodiments, to ensure the required strength of magnetic field for retention force between the charger case and the ear-worn device is achieved, highest grade magnets made from materials such as neodymium and samarium-cobalt can be used. These materials ensure that the magnets maintain their magnetic strength over time, even with repeated use, thereby guaranteeing the longevity and reliability of the alignment mechanism.

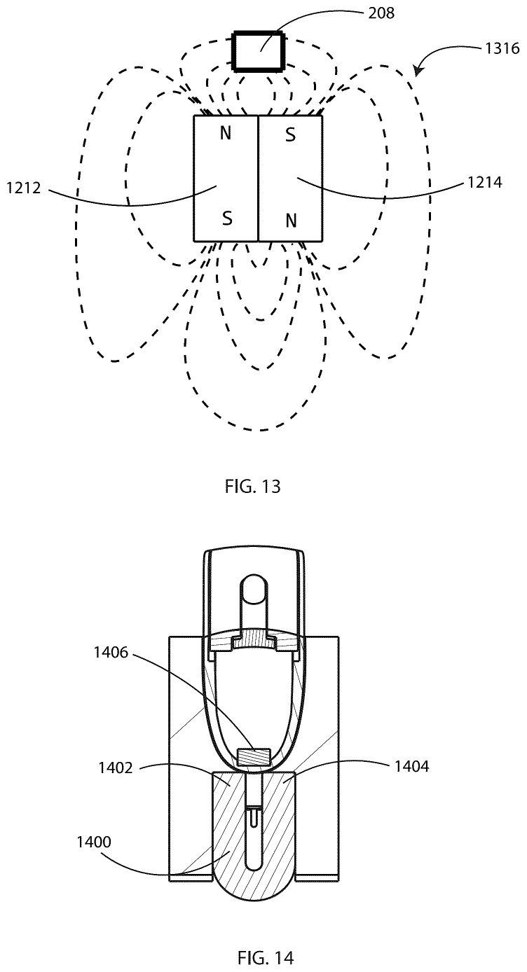

The attractive force between the magnetic material and the magnets can be illustrated as shown in FIG. 13. Referring now to FIG. 13, a schematic diagram of a polarity alignment of a pair of magnets with a magnetic material is shown in accordance with various embodiments herein. The magnetic material 208 can be magnetically attracted to the first pole-aligned magnet 1212 and a second pole-aligned magnet 1214. The magnets 1212 and 1214 can be designed to exert a precise magnetic force, which is strong enough to securely hold the ear-worn device in place during the charging process.

In some embodiments, the first pole-aligned magnet 1212 and the second pole-aligned magnet 1214 can be positioned adjacent to each other. In some embodiments, the first pole-aligned magnet 1212 and the second pole-aligned magnet 1214 can be positioned adjacent and in contact with each other. In other embodiments, the first pole-aligned magnet 1212 and the second pole-aligned magnet 1214 can be spaced apart from each other. It is noted that the first pole-aligned magnet 1212 and the second pole-aligned magnet 1214 should be positioned so that magnetic fields 1316 interact with the magnetic material 208 to generate appropriate retention force within the ear-worn device. This is achieved by aligning the magnets 1212 and 1214 in a specific polarity arrangement, where the first pole-aligned magnet 1212 and the second pole-aligned magnet 1214 are positioned with opposite poles facing towards the magnetic material 20. Such an arrangement enhances the magnetic attraction between the charger case and the ear-worn device, ensuring a strong and reliable connection. For example, as FIG. 13 illustrates, the north pole of the first pole-aligned magnet 1212 can be positioned proximal to the magnetic material 208 while the south pole is positioned distal to the magnetic material 208 and the south pole of the second pole-aligned magnet 1214 can be positioned proximal to the magnetic material 208 while the north pole is positioned distal to the magnetic material 208

This arrangement of the magnets 1212 and 1214 achieves sufficient attraction force between the ear-worn device and the charger case while eliminating excess magnetic fields within the ear-worn device when worn by the user. This removal of excess magnetic fields allows for the reduction of their impact on the performance of components within the ear-worn device reliant on the detection of magnetic fields, such as the induction pickup coil (i.e., telecoil) while eliminating the requirement of additional shielding of the magnetic fields within the ear-worn device. The reduction of the overall length of the magnetic fields 1316 going through the magnetic material 208 additionally allows for an increase in the overall attraction force between the charger case and the ear-worn device because the magnetic material 208 does not maintain its magnetism when removed from the indentation of the charger case.

In various embodiments, the retention force between the magnetic material 208 and the magnets 1212 and 1214 can be between 0.7 Newtons (N) and 2.5 N. For example, the retention force can be 1 N. In various embodiments, the magnetic material 208 can have a magnetic permeability between 300 H/m (Henries per meter) and 180,000 H/m. For example, the magnetic material 208 can have a magnetic permeability of 300 H/m, 25,000 H/m, 75,000 H/m, 125,000 H/m, 180,000 H/m, or any number in between.

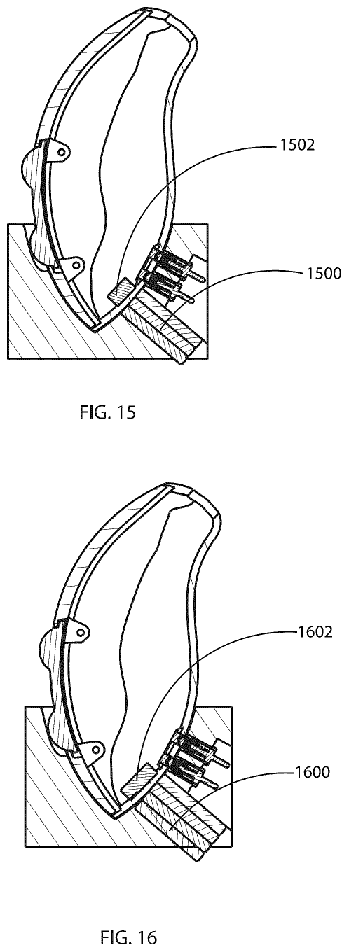

In various embodiments, alternative magnet configurations can be provided in the case charging port. Some of these alternatives modify the retention force between the soft magnetic alloy and the magnets. For example, a single magnet in a horseshoe configuration can be utilized. Referring now to FIG. 14, a cross-sectional view of an ear-worn device in a case charging port having a horseshoe magnet is shown in accordance with various embodiments herein. As illustrated, the single magnet 1400 can be positioned in a horseshoe configuration with the north pole 1402 and the south pole 1404 of the magnet 1400 being positioned proximal to the soft magnetic alloy 1406. It is further noted, that the north pole 1402 and the south pole 1404 can switch positions with no change in the effectiveness of the magnet 1400. The horseshoe configuration of the magnet 1400 can allow for a concentrated magnetic field at the open ends of the horseshoe, where the north pole 1402 and the south pole 1404 are located.

Alternatively, the retention force can be increased between the soft magnetic alloy and the magnets by adding additional magnets to the case alignment structure. Referring now to FIG. 15, a cross-sectional view of an ear-worn device in a case charging port having three magnets is shown in accordance with various embodiments herein. As illustrated, three magnets 1500 can be utilized. In some embodiments, the three magnets 1500 can exhibit alternating poles proximal to the soft magnetic alloy 1502. For example, a north pole of a first magnet can be positioned proximal to the soft magnetic alloy 1502 while south poles of a second and third magnet, each positioned on opposite sides of the first magnet, are positioned proximal to the soft magnetic alloy 1502. Referring now to FIG. 16, a cross-sectional view of an ear-worn device in a case charging port having four magnets is shown in accordance with various embodiments herein. As illustrated, four magnets 1600 can be utilized. In some embodiments, the four magnets 1600 can exhibit alternating poles proximal to the soft magnetic alloy 1602. For example, a north pole of a first magnet can be positioned proximal to the soft magnetic alloy 1602, while a south pole of a second magnet, positioned adjacent to the first magnet, can be positioned proximal to the soft magnetic alloy 1602, and a north pole of a third magnet, positioned adjacent to the second magnet, can be positioned proximal to the soft magnetic alloy 1602, and lastly, a south pole of a fourth magnet, positioned adjacent to the third magnet, can be positioned proximal to the soft magnetic alloy 1602.

It is further noted that any number of magnets can be utilized. For example, the case charging port can include one magnet, two magnets, three magnets, four magnets, five magnets, six magnets, seven magnets, eight magnets, or more, or a number of magnets falling in between these numbers. Additionally, it is noted that when three or more magnets are utilized, one or more of the central magnets can be positioned in a Halbach array such that the central magnet(s) is positioned with each of its north pole and south pole oriented towards the other magnets as opposed to having either the north pole or the south pole of the central magnet positioned proximal to the soft magnetic alloy.

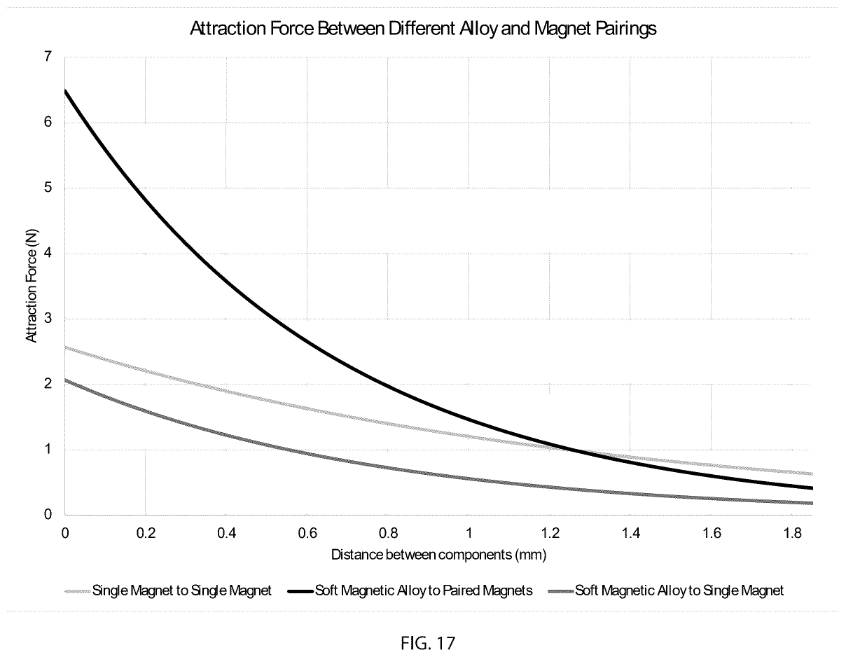

Referring now to FIG. 17, a graph of the attraction force between different alloys and magnet pairings in accordance with various embodiments herein. As illustrated, when a single magnet is attracted to a single magnet, the highest attraction (retention) force observed is approximately 2.5 N when there is no distance between the magnets. As the distance between the magnets increases, the attraction force decreases. Similarly, when a soft magnetic alloy is attracted to a single magnet, the highest attraction force observed is approximately 2 N when there is no distance between the soft magnetic alloy and the magnet and as the distance between the soft magnetic alloy and the magnet increases, the attraction force decreases. In contrast, when a soft magnetic alloy is attracted to a pair of magnets (ex. two magnets), a significant increase in the attraction force is observed. When there is no distance between the soft magnetic alloy and the pair of magnets an attraction force of approximately 6.5 N is observed. When the distance between the soft magnetic alloy and the pair of magnets is approximately 0.6 mm, an attraction force of approximately 2.5 N is observed. This illustrates the strong attraction forces between soft magnetic alloys and two magnets as discussed throughout the application.

In some embodiments, a thickness of the ear-worn device housing 102 in the vicinity of the magnetic material can be greater than or equal to 0.6 mm, 0.7 mm, 0.8 mm, 0.9 mm, 1.0 mm, 1.1 mm, or 1.2 mm, or can be an amount falling within a range between any of the foregoing.

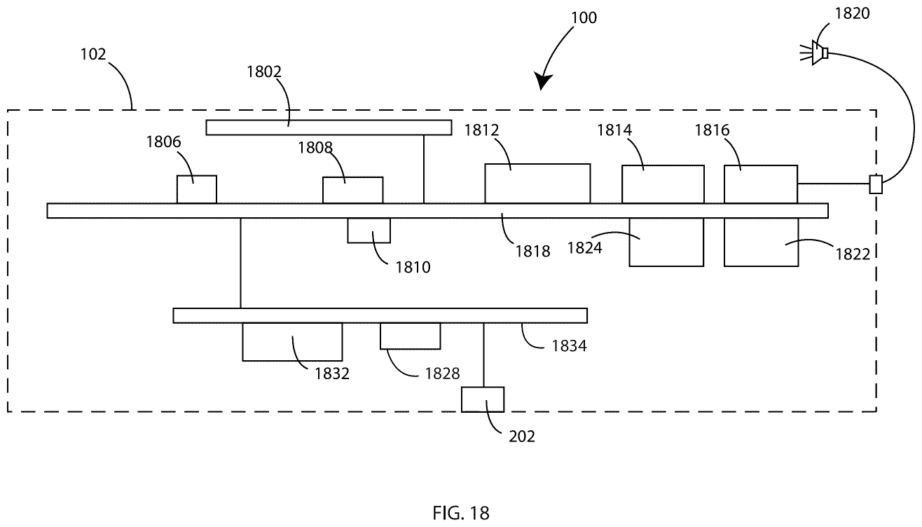

### Ear-Worn Device Schematic (FIG. 18)

Referring now to FIG. 18, a schematic block diagram is shown with various components of an ear-worn device, in accordance with various embodiments. The ear-worn device 100 shown in FIG. 18 includes several components electrically connected to a circuit board 1818, such as a flexible mother circuit (e.g., flexible mother board) which is disposed within the ear-worn device housing 102.

The ear-worn device 100 may include a charging assembly 1834 including a power management module 1828 and a rechargeable battery 1832, which are configured to provide power to the various components of the ear-worn device 100. An ear-worn device charging structure 202 is electrically connected to the rechargeable battery 1832 on the charging assembly 1834 and is configured to interface with a charging structure of a charger case.

One or more microphones 1806 are electrically connected to the circuit board 1818, which provides electrical communication between the microphones 1806 and a digital signal processor (DSP) 1812. Among other components, the DSP 1812 incorporates or is coupled to audio signal processing circuitry configured to implement various functions described herein. One or more user switches 1810 (e.g., on/off, volume, mic directional settings) are electrically coupled to the DSP 1812 via the circuit board 1818.

A sensor package 1814 can be coupled to the DSP 1812 via the circuit board 1818. The sensor package 1814 can include one or more different specific types of sensors. The ear-worn device includes an ear-worn device IMU. The IMU is configured to detect a vibration sequence as a part of a pairing method for the wireless communication device 1808, among other useful data that can be ascertained from IMU.

As used herein the term “inertial measurement unit” or “IMU” shall refer to an electronic device that can generate signals related to a body's specific force and/or angular rate. IMUs herein can include one or more accelerometers (3, 6, or 9 axis) to detect linear acceleration, a gyroscope to detect rotational rate, or both. In some embodiments, in the alternative or in addition, an IMU includes a magnetometer to detect a magnetic field.

An audio output device 1816 is electrically connected to the DSP 1812 via the circuit board 1818. In some embodiments, the audio output device 1816 comprises a speaker (coupled to an amplifier). In other embodiments, the audio output device 1816 comprises an amplifier coupled to an external receiver 1820 adapted for positioning within an ear of a wearer. The external receiver 1820 can include an electroacoustic transducer or speaker.

The ear-worn device 100 may incorporate a wireless communication device 1808 coupled to the circuit board 1818 and to an antenna 1802 directly or indirectly via the circuit board 1818. The communication device 1808 can be a Bluetooth® transceiver, such as a BLE (Bluetooth® low energy) transceiver or another transceiver (e.g., an IEEE 802.11 compliant device). The communication device 1808 can be configured to communicate with one or more external devices, such as a wireless communication device of a charger case, a wireless communication device of another ear-worn device, a wireless communication device of a smart phone, or a wireless communication device of another system, such as other systems discussed herein, in accordance with various embodiments. In various embodiments, the communication device 1808 can be configured to communicate with an external visual display device such as a smart phone, a video display screen, a tablet, a computer, or the like.

In various embodiments, the ear-worn device 100 can also include a control circuit 1822 and a memory storage device 1824. The control circuit 1822 can be in electrical communication with other components of the device. The control circuit 1822 can execute various operations, such as those described herein. The control circuit 1822 can include various components including, but not limited to, a microprocessor, a microcontroller, an FPGA (field-programmable gate array) processing device, an ASIC (application specific integrated circuit), or the like. The memory storage device 1824 can include both volatile and non-volatile memory. The memory storage device 1824 can include ROM, RAM, flash memory, EEPROM, SSD devices, NAND chips, and the like. The memory storage device 1824 can be used to store data from sensors as described herein and/or processed data generated using data from sensors as described herein, including, but not limited to, information regarding exercise regimens, performance of the same, visual feedback regarding exercises, and the like.

It is noted that the structure and housing of a second ear-worn device is not illustrated herein but may be similar to or identical to the first ear-worn device.

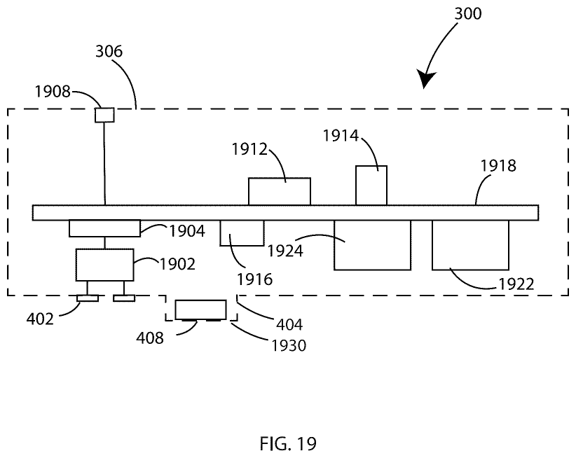

### Charger Case Schematic (FIG. 19)

FIG. 19 is a schematic block diagram of a charger case shown in accordance with various embodiments herein. In various embodiments, a charger case 300 includes a case battery 1902, a case processor 1912, a case sensor package 1914, a case control circuit 1922, and a case non-transitory computer memory 1924, which each can be connected to a circuit board 1918. The charger case 300 also includes a case main body 306. The charger case 300 also includes a power supply circuit 1904 connected to a case charging structure 402 and the case battery 1902. The charger case 300 also includes case display 1916 and an interface port 1908.

The charger case 300 can include a case alignment structure 404 configured to align with an ear-worn alignment structure. The case alignment structure 404 can be a mechanically-mating structure, such as an indentation in the charging case. In addition, or alternatively, the case alignment structure 404 can include a protrusion 1930 that mates with a depression on the ear-worn device. The case alignment structure 404 can include a pair of magnets 408 that interacts with a magnetic material in the ear-worn device.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. An ear-worn device system for listening comprising:
a first ear-worn device comprising a speaker, a rechargeable battery, a first ear-worn device charging structure comprising a first ear-worn device electrical contact, and an ear-worn device alignment structure comprising a magnetic material; and
a charger case comprising a first case charging structure and a case alignment structure, wherein the first case charging structure comprises a first case electrical contact, wherein the case alignment structure comprises a first pole-aligned magnet and a second pole-aligned magnet, and wherein the first pole-aligned magnet and the second pole-aligned magnet are opposite poles and are positioned on a first side of the case alignment structure, and wherein the magnetic material is magnetically attracted to the first pole-aligned magnet and the second pole-aligned magnet; and
wherein the first ear-worn device is configured to be positioned within the charger case so that the first ear-worn device electrical contact is in electrical communication with the first case electrical contact within the charger case; and
wherein the ear-worn device alignment structure is configured to retain the first ear-worn device electrical contact to the first case electrical contact within the charger case.

2. The ear-worn device system of claim 1, wherein the first pole-aligned magnet comprises a north pole and the second pole-aligned magnet comprises a south pole.

3. The ear-worn device system of claim 1, wherein the case alignment structure comprises a third pole-aligned magnet.

4. The ear-worn device system of claim 3, wherein the case alignment structure comprises a fourth pole-aligned magnet.

5. The ear-worn device system of claim 1, wherein the first pole-aligned magnet and the second pole-aligned magnet are bar magnets.

6. The ear-worn device system of claim 1, wherein the first pole-aligned magnet and the second pole-aligned magnet are positioned adjacent to one another.

7. The ear-worn device system of claim 6, wherein the first pole-aligned magnet and the second are in contact with each other.

8. The ear-worn device system of claim 6, wherein the magnetic material does not retain its magnetism when removed from the charger case.

9. The ear-worn device system of claim 1, wherein a retention force of equal to or greater than 0.7 Newtons (N) is present between the first ear-worn device and the charger case when the first ear-worn device alignment structure is positioned at least partially within an indentation of the charger case.

10. The ear-worn device system of claim 9, wherein the retention force is equal to or less than 2.5 N when the first ear-worn device alignment structure is positioned at least partially within the indentation of the charger case.

11. The ear-worn device system of claim 1, wherein the first pole-aligned magnet and the second pole-aligned magnet are included in a horseshoe magnet.

12. The ear-worn device system of claim 1, wherein the first pole-aligned magnet and the second pole-aligned magnet comprise a material selected from the group consisting of neodymium and samarium-cobalt.

13. The ear-worn device system of claim 1, wherein the magnetic material comprises a material selected from the group consisting of stainless steel, an iron-cobalt alloy, a silicon iron alloy, and a nickel iron alloy.

14. The ear-worn device system of claim 13, wherein a magnetic permeability of the magnetic material is between 300 H/m and 180,000 H/m.

15. An ear-worn device system for listening comprising:
a first ear-worn device comprising a speaker, a rechargeable battery, a first ear-worn device charging structure comprising at least two first ear-worn device electrical contacts, and an ear-worn device alignment structure comprising a magnetic material; and
a charger case comprising a first case charging structure and a case alignment structure, wherein the first case charging structure comprises at least two first case electrical contacts, wherein the case alignment structure comprises a first pole-aligned bar magnet and a second pole-aligned bar magnet, and wherein the first pole-aligned bar magnet and the second pole-aligned bar magnet are opposite poles and are positioned on a first side of the case alignment structure, and wherein the magnetic material is magnetically attracted to the first pole-aligned bar magnet and the second pole-aligned bar magnet; and
wherein the first ear-worn device is configured to be positioned within the charger case so that the at least two first ear-worn device electrical contacts are in electrical communication with the least two first case electrical contacts within the charger case;
wherein the ear-worn device alignment structure is configured to retain the at least two first ear-worn device electrical contacts to the at least two first case electrical contacts within the charger case; and
wherein the magnetic material does not retain its magnetism when removed from the charger case.

16. The ear-worn device system of claim 15, wherein the first pole-aligned bar magnet comprises a north pole and the second pole-aligned bar magnet comprises a south pole.

17. The ear-worn device system of claim 15, wherein a retention force of equal to or greater than 0.7 N is present between the first ear-worn device and the charger case when the first ear-worn device alignment structure is positioned at least partially within an indentation of the charger case.

18. The ear-worn device system of claim 17, wherein the retention force is equal to or less than 2.5 N when the first ear-worn device alignment structure is positioned at least partially within the indentation of the charger case.

19. The ear-worn device system of claim 15, wherein the first pole-aligned bar magnet and the second pole-aligned bar magnet comprise a material selected from the group consisting of neodymium and samarium-cobalt.

20. The ear-worn device system of claim 15, wherein the magnetic material comprises a material selected from the group consisting of stainless steel, an iron-cobalt alloy, a silicon iron alloy, and a nickel iron alloy.
